(19) United States
(12) Patent Application Publication
(10) Pub. No.: US 2014/0170506 A1
(43) Pub. Date: Jun. 19, 2014

(54) NONAQUEOUS SOLVENT FOR ELECTRICITY STORAGE DEVICE, NONAQUEOUS ELECTROLYTIC SOLUTION AND ELECTRICITY STORAGE DEVICE AND LITHIUM SECONDARY BATTERY USING THE SAME

(71) Applicant: PANASONIC CORPORATION, Osaka (JP)

(72) Inventors: Takashi TAKEUCHI, Osaka (JP); Masaki HASEGAWA, Osaka (JP); Natsumi GOTO, Hyogo (JP)

(73) Assignee: PANASONIC CORPORATION, Osaka (JP)

(21) Appl. No.: 14/108,146

(22) Filed: Dec. 16, 2013

Related U.S. Application Data
(60) Provisional application No. 61/739,423, filed on Dec. 19, 2012.

(51) Int. Cl. H01M 10/0569; H01M 10/052

(52) U.S. Cl. CPC H01M 10/0569; H01M 10/052
USPC 429/338; 549/449

(57) ABSTRACT

A nonaqueous solvent for an electricity storage device includes a fluorine-containing cyclic carbonate represented by the following general formula (1) (in general formula (1), R₁ is a methyl group or an ethyl group; R₂ through R₄ are independently fluorine, a methyl group or an ethyl group; and at least one of R₂ through R₄ is fluorine):

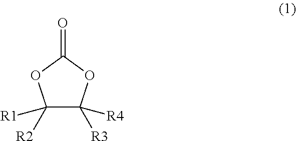

This application claims priority under 35 USC §119(e) to U.S. Provisional Application No. 61/739,423 filed on Dec. 19, 2012, the entire contents of which are incorporated herein by reference.

### BACKGROUND OF THE INVENTION

1. Field of the Invention

The present application relates to a nonaqueous solvent and a nonaqueous electrolytic solution usable for an electrical storage device for storing or accumulating electrochemical energy, and an electrical storage device using the same, such as a lithium secondary battery or the like.

2. Description of the Related Art

Recently, lithium secondary batteries having a high discharge voltage of 4 V class have been a target of attention as a high energy density storage battery, and such secondary batteries have been actively developed.

A lithium secondary battery generally includes a nonaqueous electrolytic solution. A reason for this is that if water is contained in an electrolytic solution, there occurs a problem that active lithium reacts with water. The nonaqueous electrolytic solution may have a high conductivity and a low viscosity in order to improve the discharge performance of an electricity storage device in which the nonaqueous electrolytic solution is used. A solvent for an electrolytic solution of a secondary battery may be chemically and electrochemically stable so as not to be deteriorated in performance by repeated charge and discharge of the secondary battery. From these viewpoints, a preferably used main solvent for an electrolytic solution of a lithium secondary battery is, for example, a mixed system of a cyclic carbonate represented by ethylene carbonate and a chain carbonate represented by ethylmethyl carbonate or dimethyl carbonate.

Recently, lithium secondary batteries have been widely used as a main power source, a backup power source or an electric circuit power source of mobile communication devices or mobile electronic devices. As these devices become more compact and have higher performance, the lithium secondary batteries are now desired to have a higher volumetric energy density. In order to raise the volumetric energy density, it is conceivable to raise the average discharge voltage or the volumetric capacitance density. For such a purpose, it has been studied to increase the charge voltage.

With a lithium secondary battery, the utilization factor of lithium in a positive electrode material can be improved by increasing the charge voltage. As a result, the volumetric capacitance density is raised. A generally usable positive electrode material is a lithium-containing lamellar transition metal oxide such as lithium cobalt oxide, lithium nickel oxide or the like. The volumetric capacitance density can be raised by charging such a positive electrode material at a higher voltage. A new positive electrode material such as, for example, spinel-type lithium-nickel-manganese composite oxide having a reaction potential of 4.7 V, which is higher than the reaction potential of the above-described positive electrode materials, is now being studied.

However, there is the following problem. When either one of a pair of electrodes is charged to a level equal to or higher than 4.3 V (potential on the basis of the standard redox potential of Li), even a chain carbonate or a cyclic carbonate, which is a high voltage-resistant solvent, is oxidative-decomposed to generate gas. This decomposition reaction proceeds conspicuously especially in a high temperature state and generates a large amount of gas. In the case where an inner pressure-sensing current interrupt device (CID) is provided in a lithium secondary battery, the generated gas raises an inner pressure of the lithium secondary battery. This may possibly actuate the CID and cause the lithium secondary battery to lose the function as a battery. Even in the case where the CID is not provided, there occurs a problem that the battery, especially, a square or rectangular battery, is expanded when a large amount of gas is generated.

As a measure for suppressing such oxidative decomposition of the electrolytic solution, Japanese Laid-Open Patent Publication No. 2005-78820 discloses an electrolytic solution containing a cyclic carbonate and a chain carbonate, in which at least one of the cyclic carbonate and the chain carbonate contains a fluorine atom. According to Japanese Laid-Open Patent Publication No. 2005-78820, a nonaqueous electrolytic solution secondary battery containing lithium-nickel-manganese composite oxide, represented by general formula LiₓNi_{y}Mn_{2-y}O_{4-δ} (where 0<x<1.1, 0.45<y<0.55, δ<0.4) as a positive electrode active material and having a working voltage of 5 V class has the following problem. Since the working voltage is high, the nonaqueous solvent contained in the electrolytic solution is oxidative-decomposed when the battery is charged. As a result, the electrolytic solution is dried up, which decreases the charge/discharge cycle characteristic. However, use of the above-described electrolytic solution results in formation of a stable oxidation-resistant film on a surface of the positive electrode active material. This suppresses the reaction between the positive electrode and the solvent, which improves the charge/discharge cycle characteristic. Also according to Japanese Laid-Open Patent Publication No. 2005-78820, substitution of at least a part of hydrogen atoms in the cyclic carbonate or the chain carbonate with fluorine atoms stabilizes the molecular structure, improves the oxidation resistance, and thus suppresses the oxidative decomposition. Japanese Laid-Open Patent Publication No. 2005-78820 discloses that as a compound obtained as a result of substituting at least a part of the hydrogen atoms in the cyclic carbonate with fluorine atoms, a fluorinated cyclic carbonate represented by the following general formula (2) is usable. Specifically listed in Japanese Laid-Open Patent Publication No. 2005-78820 are 4-fluoro-1,3-dioxorane-2-one (fluorinated ethylene carbonate, FEC), 4,5-tetrafluoro-1,3-dioxorane-2-one, and 4-trifluoromethyl-1,3-dioxorane-2-one (fluorinated propylene carbonate).

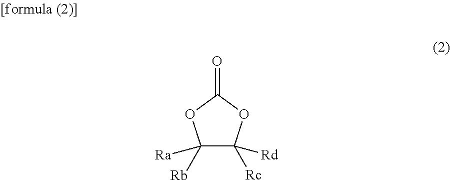

In chemical formula (2), Ra, Rb and Rc each represent a hydrogen atom, and Rd represents a hydrogen atom or an alkyl group. The hydrogen atoms represented by Ra, Rb, Rc and Rd are partially or entirely substituted with F atoms.

### SUMMARY OF THE INVENTION

However, regarding the oxidation-resistance and the chemical stability, further improvement over the above-described conventional art has been desired. A non-limiting illustrative embodiment of the present application provides a nonaqueous solvent and a nonaqueous electrolytic solution for an electricity storage device, and an electricity storage device and a lithium secondary battery, which have a splendid oxidation resistance and a splendid chemical stability.

A nonaqueous solvent for an electricity storage device in an embodiment according to the present application includes a fluorine-containing cyclic carbonate represented by the following general formula (1) (in general formula (1), R₁ is a methyl group or an ethyl group; R₂ through R₄ are independently fluorine, a methyl group or an ethyl group; and at least one of R₂ through R₄ is fluorine):

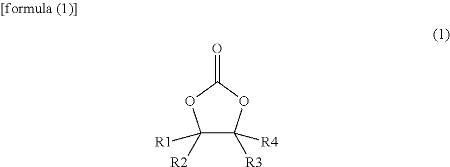

A nonaqueous solvent for an electricity storage device according to an embodiment of the present application includes a fluorine-containing cyclic carbonate represented by general formula (1), and owing to this, exhibits a high oxidation resistance and a high chemical stability. Therefore, an electricity storage device can be realized by use of a positive electrode having a high voltage of 5 V class. In addition, actuation of a safety mechanism or expansion of an electricity storage device, which would otherwise be caused by gas generated by oxidative decomposition or chemical decomposition of a nonaqueous solvent, can be suppressed.

### BRIEF DESCRIPTION OF THE DRAWINGS

FIG. 1A is an isometric view showing a lithium secondary battery in an embodiment according to the present application.

FIG. 1B is a cross-sectional view showing a lithium secondary battery in an embodiment according to the present application.

FIG. 1C is an enlarged cross-sectional view of an electrode unit 13 shown in FIG. 1A and FIG. 1B.

FIG. 2 is a cross-sectional view showing a three-electrode glass cell used in Experiment 1.

FIG. 3 shows voltage-current curves of Example 1-1, Comparative example 1-2 and Conventional example 1-3 obtained in Experiment 1 in the three-electrode glass cell by a linear sweep voltammetry method.

FIG. 4 is a flowchart showing an experiment technique for gas generation evaluation in Experiment 2.

FIG. 5 shows the size of a positive electrode used in Experiments 2, 3 and 4.

FIG. 6 shows the size of a negative electrode used in Experiments 2, 3 and 4.

FIG. 7A is an isometric view showing a battery produced in the step of charging the positive electrode in Experiment 2.

FIG. 7B is a cross-sectional view of the battery produced in the step of charging the positive electrode in Experiment 2.

FIG. 7C is an enlarged cross-sectional view of an electrode unit 23 shown in FIG. 7A and FIG. 7B.

FIG. 8A shows a charge/discharge curve of a battery in Example 3-1-A.

FIG. 8B shows a charge/discharge curve of a battery in Example 3-1-B.

FIG. 8C shows a charge/discharge curve of a battery in Conventional example 3-3.

FIG. 9A shows a charge/discharge curve of a battery in Example 4-1.

FIG. 9B shows a charge/discharge curve of a battery in Comparative example 4-2.

FIG. 9C shows a charge/discharge curve of a battery in Conventional example 4-3.

### DETAILED DESCRIPTION OF PREFERRED EMBODIMENTS

The inventors of the present application made detailed studies on a lithium secondary battery using, as a solvent, 4-fluoro-1,3-dioxorane-2-one (fluorinated ethylene carbonate, FEC), which is disclosed in Japanese Laid-Open Patent Publication No. 2005-78820 as a specific example of compound obtained as a result of substituting at least a part of the hydrogen atoms in the cyclic carbonate with fluorine atoms. As a result of the studies, it was found that this lithium secondary battery provides a certain effect of improving the oxidation resistance and thus reduces the amount of gas generated when being stored at a high temperature and a high voltage as compared with a lithium secondary battery using 1,3-dioxorane-2-one (ethylene carbonate, EC), which is conventionally used generally, but the effect is not sufficient. It was also found that a lithium secondary battery which uses, as a solvent, 4,4,5,5-tetrafluoro-1,3-dioxorane-2-one also disclosed in Japanese Laid-Open Patent Publication No. 2005-78820 is expected to improve the oxidation resistance but significantly decreases reduction resistance. Such a significant decrease in reduction resistance occurs because four electron-withdrawing fluorine atoms are introduced and thus the electron density on the cyclic carbonate skeleton is decreased. Based on these findings, it is considered difficult, from the viewpoints of reduction resistance, to use 4,4,5,5-tetrafluoro-1,3-dioxorane-2-one as a solvent for an electrolytic solution in a lithium secondary battery including a positive electrode having a high potential and a negative electrode having a low potential.

The inventors of the present application studied, in more detail, the process in which gas is generated from 4-fluoro-1,3-dioxorane-2-one. It was found that 4-fluoro-1,3-dioxorane-2-one itself has a sufficient oxidation resistance but is chemically decomposed to generate 1,3-dioxole-2-one (vinylene carbonate, VC), which has a significantly low oxidation resistance. As can be seen, the research made by the inventors of the present application clarified that when 4-fluoro-1,3-dioxorane-2-one, which is disclosed in Japanese Laid-Open Patent Publication No. 2005-78820, is used for a lithium secondary battery having a high discharge voltage, the problem occurs that 1,3-dioxole-2-one, which is generated by decomposition of 4-fluoro-1,3-dioxorane-2-one at a high temperature and a high voltage, is oxidative-decomposed and thus gas is generated.

In light of this problem, the inventors of the present application conceived a novel nonaqueous solvent and a novel nonaqueous electrolytic solution for an electricity storage device, which are splendid in oxidation resistance and chemical stability. The inventors of the present application also conceived a novel nonaqueous solvent and a novel nonaqueous electrolytic solution for an electricity storage device, which do not generate a large amount of gas. In addition, the inventors of the present application also conceived a lithium secondary battery and an electricity storage device which use such a nonaqueous solvent and such a nonaqueous electrolytic solution for an electricity storage device and thus have a high charge/discharge characteristic even when being charged at a high voltage and have a high reliability for a long time even in a high temperature state.

A nonaqueous solvent for an electricity storage device n an embodiment according to the present application includes a fluorine-containing cyclic carbonate represented by the following general formula (1) (in general formula (1), R₁ is a methyl group or an ethyl group; R₂ through R₄ are independently fluorine, a methyl group or an ethyl group; and at least one of R₂ through R₄ is fluorine):

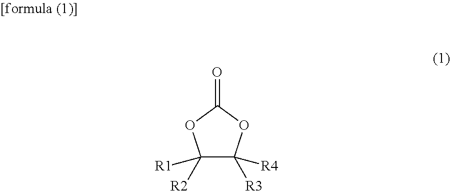

The fluorine-containing cyclic carbonate represented by general formula (1) may be 4,5-difluoro-4,5-dimethyl-1,3-dioxorane-2-one.

A nonaqueous electrolytic solution for an electricity storage device in an embodiment according to the present application includes the nonaqueous solvent for an electricity storage device defined any of the above; and a support electrolyte salt.

The support electrolyte salt may be a lithium salt.

The support electrolyte salt may be a quaternary ammonium salt.

A lithium secondary battery in an embodiment according to the present application includes a positive electrode; a negative electrode; and the nonaqueous electrolytic solution for an electricity storage device.

The negative electrode may include Li₄Ti₅O₁₂.

The positive electrode may include LiNi_{0.33}CO_{0.33}Mn_{0.33}O₂.

The positive electrode may include LiNi_{0.5}Mn_{1.5}O₄.

The positive electrode of the lithium secondary battery may be constructed to be charged at a potential in the range of 4.3 V or higher and 5.0 V or less on the basis of a standard redox potential of lithium.

### Embodiment 1

Hereinafter, a nonaqueous solvent for an electricity storage device in an embodiment according to the present application will be described. A nonaqueous solvent for an electricity storage device in this embodiment includes a fluorine-containing cyclic carbonate represented by general formula (1).

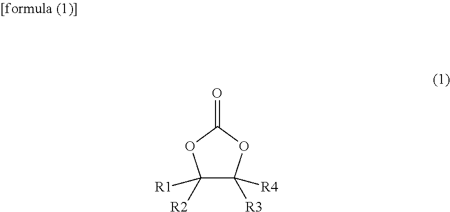

In general formula (1), R₁ through R₄ are independently fluorine, a methyl group or an ethyl group. At least one of R₁ through R₄ is fluorine.

In the fluorine-containing cyclic carbonate represented by general formula (1), at least one fluorine atom is bonded to two carbons which form a five-member ring. Owing to the effect of this strong electron-withdrawing property of the fluorine atom, the electron density of the carbonate skeleton is decreased and thus the carbonate skeleton exhibits a higher stability against oxidation than a carbonate skeleton including no fluorine atom. R₁ through R₄ are independently fluorine, a methyl group or an ethyl group, and do not contain any hydrogen group. Therefore, the fluorine-containing cyclic carbonate represented by general formula (1) has a splendid chemical stability and a splendid oxidation resistance.

By contrast, in the case where a fluorine atom is bonded to one of two carbons at positions 4 and 5 of the 5-member ring of the carbonate skeleton and a hydrogen atom is bonded to the other carbon, for example, in the case of the compound represented by general formula (2) disclosed in Japanese Laid-Open Patent Publication No. 2005-78820, a reaction that the hydrogen atom and the fluorine atom respectively bonded to the continuous two carbons are eliminated as HF easily occurs due to chemical decomposition. Such a carbon skeleton is inferior in chemical stability. The elimination of HF results in formation of a carbon-carbon double bond in the 5-member ring of the cyclic carbonate. The carbon-carbon double bond is vulnerable to an oxidation reaction, and therefore, decomposition, gasification or polymerization occurs due to the oxidation reaction. Specifically, as described above, 4-fluoro-1,3-dioxorane-2-one, which is a compound disclosed in Japanese Laid-Open Patent Publication No. 2005-78820, has HF eliminated therefrom by a chemical decomposition to generate 1,3-dioxole-2-one, which has a carbon-carbon double bond. 1,3-dioxole-2-one has a low oxidation resistance and thus is oxidative-decomposed relatively easily when contacting a positive electrode in a high potential state. As a result, CO₂ is generated.

The fluorine-containing cyclic carbonate represented by general formula (1) does not have any hydrogen atom on the carbon at position 4 or 5. Therefore, there is no mechanism for allowing fluorine atoms on the carbons at positions 4 and 5 to be eliminated as HF. Thus, a compound having a carbon-carbon double bond on the cyclic carbonate skeleton and thus having a low oxidation resistance is not generated. Hence, no gas is generated.

In general formula (1), R₁ through R₄ are independently a fluorine atom or an alkyl group. The alkyl group may be a methyl group or an ethyl group having a carbon number of 1 or 2. In the case where the alkyl group has a carbon number of 3 or more, the molecular weight is large, and thus the diffusion rate of the fluorine-containing cyclic carbonate is decreased. This raises the liquid viscosity, and decreases the ion conductivity and the impregnability to the inside of the electrode. For these reasons, a cyclic carbonate represented by general formula (1) including an alkyl group having a carbon number of 3 or more is not preferable as a nonaqueous solvent for an electricity storage device.

In the case where two or more among R₁ through R₄ in general formula (1) are independently a methyl group or an ethyl group, all of R₁ through R₄ may each be a methyl group or all of R₁ through R₄ may each be an ethyl group. Alternatively, R₁ through R₄ may contain both of a methyl group and an ethyl group.

Specific examples of the solvent having the molecular structure of general formula (1) include 4,4,5-trifluoro-5-methyl-1,3-dioxorane-2-one, 4,4-difluoro-5,5-dimethyl-1,3-dioxorane-2-one, 4,4-difluoro-4,5-dimethyl-1,3-dioxorane-2-one, 4-fluoro-4,5,5-trimethyl-1,3-dioxorane-2-one, 4,4,5-trifluoro-5-ethyl-1,3-dioxorane-2-one, 5-ethyl-4,4-difluoro-5-methyl-1,3-dioxorane-2-one, 5,5-diethyl-4,4-difluoro-1,3-dioxorane-2-one, 4-ethyl-4,5-difluoro-5-ethyl-1,3-dioxorane-2-one, 4-ethyl-4,5-difluoro-5-ethyl-1,3-dioxorane-2-one, 4,5-diethyl-4,5-difluoro-1,3-dioxorane-2-one, 4-ethyl-5-fluoro-4,5-dimethyl-1,3-dioxorane-2-one, 5-ethyl-5-fluoro-4,4-dimethyl-1,3-dioxorane-2-one, 4,4-diethyl-5-fluoro-5-methyl-1,3-dioxorane-2-one, 4,5-diethyl-5-fluoro-4-methyl-1,3-dioxorane-2-one, 4,4,5-triethyl-5-fluoro-1,3-dioxorane-2-one, and the like.

The fluorine-containing cyclic carbonate represented by general formula (1) is increased in oxidation resistance as the number of fluorine atoms in a molecule is increased. Therefore, when a high oxidation resistance is required, a compound including three fluorine atoms may be used among the above-listed compounds. However, as the number of fluorine atoms in a molecule is increased, the reduction resistance is decreased. Therefore, in the case where an electricity storage device is constructed using a compound including three fluorine atoms in a molecule, among the fluorine-containing cyclic carbonates represented by general formula (1), as a nonaqueous solvent for the electricity storage device, a negative electrode active material may be a material having a redox reaction potential higher than the standard redox potential of lithium, for example, lithium titanate.

For the above-described reasons, among fluorine-containing cyclic carbonates represented by general formula (1), a fluorine-containing cyclic carbonate containing two fluorine atoms in a molecule, namely, a fluorine-containing cyclic carbonate in which two of R₁ through R₄ are fluorine atoms and the remaining two of R₁ through R₄ are each a methyl group or an ethyl group, has a splendid oxidation resistance and also has a splendid reduction resistance owing to having an appropriate electron density on the cyclic carbonate skeleton. Such a fluorine-containing cyclic carbonate is suitable as a nonaqueous solvent for various types of electricity storage devices. Specifically, a nonaqueous solvent for an electricity storage device in this embodiment may include 4,5-difluoro-4,5-dimethyl-1,3-dioxorane-2-one, which has a splendid chemical stability and a good balance between the oxidation resistance and the reduction resistance.

As described later in examples, the nonaqueous solvent for an electricity storage device in this embodiment has a high oxidation resistance by which the nonaqueous solvent is not substantially oxidized by up to about 5.0 V on the basis of the lithium standard potential. Therefore, the nonaqueous solvent in this embodiment is preferably usable for an electricity storage device which is charged at a voltage in the range of 4.3 V or higher and 5.0 V or less, at which conventionally representative nonaqueous solvents for an electricity storage device, for example, ethylene carbonate, ethylmethyl carbonate, dimethyl carbonate, propylene carbonate and the like are oxidized.

In general, a fluorine-containing cyclic carbonate represented by general formula (1) can be synthesized by a fluorination method using F₂, NF₃, HF, XeF₂, SF₄, CF₃I, C₂F₅I, DAST (dimethylaminosulfur trifluoride), bis(2-methoxyethyl)aminosulfur trifluoride, tetrabutylammonium fluoride, trimethyl(trifluoromethyl)silane or the like

Among the above-listed compounds, a compound containing two fluorine atoms can be synthesized by a method disclosed in example 1 of Japanese Laid-Open Patent Publication No. 2009-203225. For example, 4,5-difluoro-4,5-dimethyl-1,3-dioxorane-2-one is obtained by reacting 2,3-butanedione and carbonyl difluoride in an autoclave. When necessary, a trans-optical isomer and a cis-optical isomer can be separated from each other by an Oldershaw fractionation device.

The nonaqueous solvent for an electricity storage device in this embodiment exhibits a high oxidation resistance owing to including a fluorine-containing cyclic carbonate represented by general formula (1). Therefore, when the nonaqueous solvent for an electricity storage device in this embodiment is used to construct an electricity storage device, a positive electrode having a high redox reaction potential of 5 V class (potential on the basis of the standard redox potential of Li) may be used. In addition, malfunctioning of a safety mechanism (CID) and expansion of the electricity storage device, which would otherwise be caused due to oxidative decomposition of the nonaqueous solvent, are suppressed. Therefore, even when lithium titanate having a redox reaction potential of 1.5 V (potential on the basis of the standard redox potential of Li) is used as a negative electrode active material, a sufficient battery voltage which is practically usable can be generated. As a result, a high energy density can be provided. In the case where lithium titanate is used as a negative electrode active material, the high redox reaction potential can suppress performance deterioration, which would otherwise be caused by deposition of lithium metal on the negative electrode or by an influence of a reduction product due to an electrolytic solution. Thus, the life of the electricity storage device can be extended. In this manner, use of the nonaqueous solvent for an electricity storage device in this embodiment provides an electricity storage device having a long life and a high energy density, such as a lithium secondary battery.

Oxidation of the nonaqueous solvent in an electricity storage device is governed by the reaction rate, which depends on the concentration. Therefore, the above-described effect is provided in accordance with the content of the fluorine-containing cyclic carbonate represented by general formula (1) in the nonaqueous solvent for an electricity storage device. As long as the nonaqueous solvent includes a fluorine-containing cyclic carbonate represented by general formula (1), the oxidation resistance of the nonaqueous solvent in the electricity storage device is increased, and the gas generation in the electricity storage device is suppressed. For this reason, the nonaqueous solvent for an electricity storage device in this embodiment may include a known nonaqueous solvent usable for an electricity storage device in addition to the fluorine-containing cyclic carbonate represented by general formula (1). Specifically, the nonaqueous solvent for an electricity storage device in this embodiment may include a cyclic carbonate such as ethylene carbonate, propylene carbonate, butylene carbonate, vinylene carbonate or the like; or a chain carbonate such as dimethyl carbonate, diethyl carbonate, ethylmethyl carbonate, dipropyl carbonate or the like.

In order to allow the above-described conspicuous effect to be provided, the fluorine-containing cyclic carbonate represented by general formula (1) is contained in the nonaqueous solvent for an electricity storage device in this embodiment preferably at a content of 5% by volume or greater and 100% by volume or less, and more preferably at a content of 10% by volume or greater and 100% by volume or less. When the content of the fluorine-containing cyclic carbonate in the solvent is 10% by volume or greater, the oxidation of the nonaqueous solvent is effectively suppressed and thus the amount of generated gas is decreased.

### Embodiment 2

Hereinafter, an nonaqueous electrolytic solution for an electricity storage device in an embodiment according to the present application will be described. An electrolytic solution in this embodiment is usable for an electricity storage device such as a lithium secondary battery, an electricity double layer capacitor or the like.

A nonaqueous electrolytic solution for an electricity storage device in this embodiment includes a nonaqueous solvent and a support electrolyte salt.

The nonaqueous solvent is the nonaqueous solvent for an electricity storage device described in Embodiment 1, and includes a fluorine-containing cyclic carbonate represented by general formula (1). The nonaqueous solvent has been described in detail and will not be described here.

As the support electrolyte salt, any generally used support electrolyte salt is usable in accordance with the type of the electricity storage device, with no specific limitation. The concentration of the support electrolyte salt in the nonaqueous electrolytic solution is also adjustable. By selecting an appropriate type of fluorine-containing cyclic carbonate represented by general formula (1) and an appropriate type of support electrolyte salt, a concentration of the support electrolyte salt of 0.5 mol/L or greater and 2 mol/L or less is realized in the nonaqueous electrolytic solution for an electricity storage device in this embodiment. The nonaqueous electrolytic solution for an electricity storage device may have a support electrolyte salt concentration of, specifically, about 0.75 mol/L or greater and about 1.5 mol/L or less, and typically, of about 1 mol/L.

Examples of the support electrolyte salt usable in the case where the electrolytic solution in this embodiment is used for a lithium secondary battery include lithium salts such as LiPF₆, LiBF₄, LiAsF₆, LiClO₄, LiCF₃SO₃, LiSbF₆, LiSCN, LiCl, LiC₆H₅SO₃, LiN(CF₃SO₂)₂, LiC(CF₃SO₂)₃, C₄F₉SO₃Li, and the like; and mixtures thereof.

Examples of the support electrolyte salt usable in the case where the electrolytic solution in this embodiment is used for an electricity double layer capacitor include, in addition to the lithium salts mentioned above, quaternary ammonium salts such as (C₂H₅)₄NBF₄, (C₄H₉)₄NBF₄, (C₂H₅)₃CH₃NBF₄, (C₂H₅)₄NPF₆, (C₂H₅)₃CH₃N−N(SO₂CF₃)₂, (C₂H₅)₄N—N(SO₂CF₃)₂, and the like; and mixtures thereof.

As described in Embodiment 1, the nonaqueous electrolytic solution for an electricity storage device in an embodiment according to the present application exhibits a high oxidation resistance owing to including a fluorine-containing cyclic carbonate represented by general formula (1). Therefore, when the nonaqueous electrolytic solution for an electricity storage device in this embodiment is used to construct an electricity storage device, a positive electrode having a high redox reaction potential of 5 V class may be used. In addition, malfunctioning of a safety mechanism (CID) and expansion of the electricity storage device, which would otherwise be caused due to oxidative decomposition of the nonaqueous solvent, are suppressed. Even when lithium titanate having a redox reaction potential of 1.5 V (potential on the basis of the standard redox potential of Li) is used as a negative electrode active material, a sufficient battery voltage which is practically usable can be generated. As a result, a high energy density can be provided. In the case where lithium titanate is used as a negative electrode active material, the high redox reaction potential can suppress performance deterioration, which would otherwise be caused by deposition of lithium metal on the negative electrode or by an influence of a reduction product due to an electrolytic solution. Thus, the life of the electricity storage device can be extended. In this manner, use of a nonaqueous electrolytic solution for an electricity storage device in this embodiment provides an electricity storage device having a long life and a high energy density, such as a lithium secondary battery.

### Embodiment 3

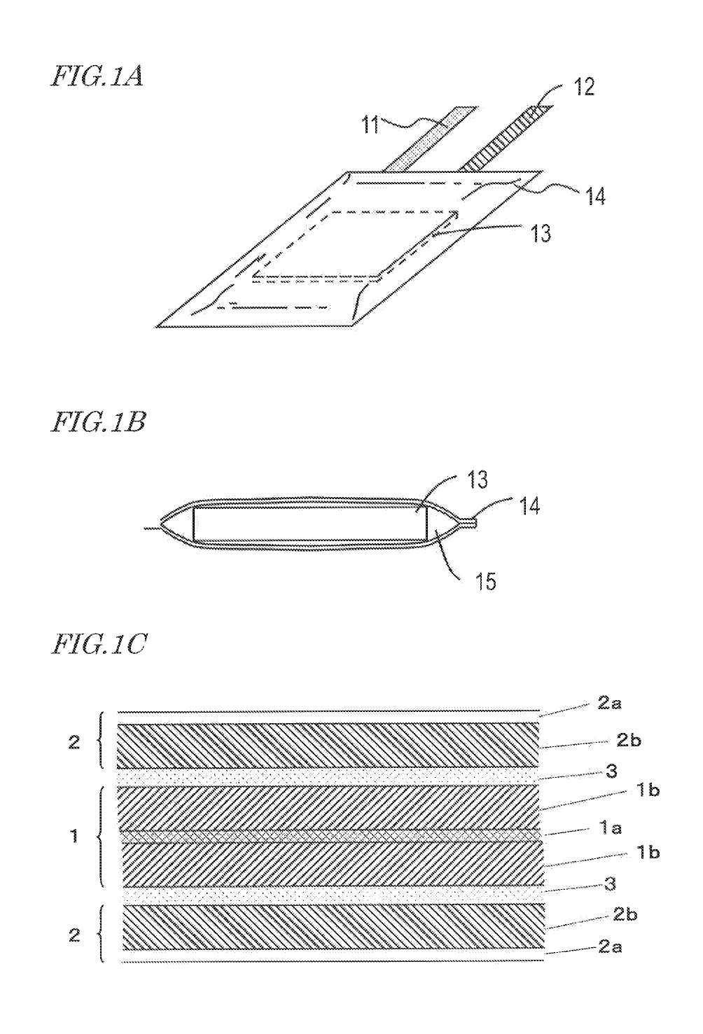

Hereinafter, an electrical storage device in an embodiment according to the present application will be described. The electrical storage device in this embodiment is a lithium secondary battery. FIG. 1A is an isometric view of a lithium secondary battery in this embodiment, and FIG. 1B is a cross-sectional view thereof.

As shown in FIGS. 1A and 1B, the lithium secondary battery in this embodiment includes an electrode unit 13, a battery case 14 for accommodating the electrode unit 13, and a nonaqueous electrolytic solution 15 filling the battery case 14. A positive electrode in the electrode unit 13 is connected to a positive electrode lead 11, and a negative electrode in the electrode unit 13 is connected to a negative electrode lead 12. The positive electrode lead 11 and the negative electrode lead 12 are extended outside the battery case 14.

As the nonaqueous electrolytic solution 15, a nonaqueous electrolytic solution for an electricity storage device described in Embodiment 2 is usable. As described in Embodiment 2, the nonaqueous electrolytic solution for an electricity storage device includes a nonaqueous solvent and a support electrolyte salt. The nonaqueous solvent contains, for example, 4,5-difluoro-4,5-dimethyl-1,3-dioxorane-2-one and ethylmethyl carbonate at a volumetric ratio of 25:75. The support electrolyte salt is, for example, LiPF₆ (commercially available battery grade). LiPF₆ is dissolved in the nonaqueous electrolytic solution for an electricity storage device at a concentration of, for example, 1 mol/L. This combination of the nonaqueous solvent and the support electrolyte salt in the nonaqueous electrolytic solution 15 is one example, and any of the various types of nonaqueous solvents and any of the various types of support electrolyte salts described in Embodiment 2 are usable.

As shown in FIG. 1C, the electrode unit 13 includes a positive electrode 1, a negative electrode 2, and a separator provided between the positive electrode 1 and the negative electrode 2. The positive electrode 1 includes a positive electrode current collector 1a formed of an aluminum foil having a thickness of 20 μm and a positive electrode active material layer 1b formed of LiNi_{0.5}Mn_{1.5}O₄ applied to a surface of the positive electrode current collector 1a. The negative electrode 2 includes a negative electrode current collector 2a formed of an aluminum foil having a thickness of 20 μm and a negative electrode active material layer 2b formed of Li₄Ti₅O₁₂ applied to a surface of the negative electrode current collector 2a. The separator 3 is formed of, for example, a polypropylene nonwoven cloth sheet.

The positive electrode active material layer 1b may be formed of a material other than LiNi_{0.5}Mn_{1.5}O₄. Examples of the usable material include LiₓCoO₂, LiₓNiO₂, LiₓMnO₂, LiₓCo_{y}Ni_{1-y}O₂, LiₓCo_{y}M_{1-y}O_{z}, LiₓNi_{1-y}M_{y}O_{z}, LiₓMn₂O₄, and LiₓMn_{2-y}M_{y}O₄ (M=at least one of Na, Mg, Sc, Y, Mn, Fe, Co, Ni, Cu, Zn, Al, Cr, Pb, Sb, and B; x=0 to 1.2; y=0 to 0.9; z=1.7 to 2.3). Any other material which makes the potential of the positive electrode 1 at the time of charge exceed 4 V on the lithium basis is usable. A plurality of different materials may be mixed as the positive electrode active material. In the case where the positive electrode active material is powdery, the average particle diameter is not limited to any specific value but may be specifically 0.1 to 30 μm. The positive electrode active material layer 1b usually has a thickness of about 50 μm to 100 μm, but may be a thin film (thickness: 0.1 μm to 10 μm) formed on the current collector 1a or may be a thick film having a thickness of 10 μm to 50 μm.

The positive electrode active material layer 1b may contain both of, or either one of, a conductor and a binder in addition to the active material. The positive electrode active material layer 1b may contain neither a conductor nor a binder and may be formed only of the active material.

The conductor for the positive electrode 1 may be any electron-conductive material which does not cause any chemical change at the charge/discharge potential of the positive electrode 1. For example, any of conductive fibers such as graphite materials, carbon black materials, carbon fibers, metal fibers and the like; metal powders; conductive whiskers; conductive metal oxides; organic conductive materials and the like may be used independently or as a mixture of two or more. The amount of the conductor is not limited to any specific value, but is preferably 1 to 50% by weight, and especially preferably 1 to 30% by weight, with respect to the positive electrode material.

The binder usable for the positive electrode 1 may be a thermoplastic resin or a thermosetting resin. Examples of the binder include polyolefin resins such as polyethylene, polypropylene and the like; fluorine-based resins such as polytetrafluoroethylene (PTFE), poly(vinylidene fluoride) (PVDF), hexafluoropropylene (HFP) and the like, and copolymeric resins thereof; and polyacrylic acids and copolymeric resins thereof.

In addition to the conductor and the binder, various other additives including a filler, a dispersant, an ion conductor, a pressure increasing agent, and the like may be used. A filler may be any fibrous material which does not cause any chemical change in the lithium secondary battery.

The material of the positive electrode current collector 1a may be any electron conductor which does not cause any chemical change at the charge/discharge potential of the positive electrode 1. Examples of the usable material include stainless steel, aluminum, titanium, carbon, conductive resins, and the like. The surface of the positive electrode current collector 1a is preferably surface-treated to have concaves and convexes. The form of the positive electrode current collector 1a may be either foil, film, sheet, net, punched, lath, porous, foamed, fibrous, molded nonwoven cloth or the like. The thickness of the positive electrode current collector 1a is not limited to any specific value, but is generally 1 to 500 μm.

The material of the negative electrode active material layer 2b may be an oxide material capable of reversibly occluding/releasing lithium other than Li₄Ti₅O₁₂. Alternatively, the material of the negative electrode active material layer 2b may be any of carbon materials such as various types of natural graphite, various types of artificial graphite, graphitizing carbon, non-graphitizing carbon and the like, or mixtures thereof; composite materials containing silicon, tin or the like which is capable of reversibly occluding/releasing lithium; or various alloy materials. It is preferable to use, for example, at least one selected from the group consisting of a single body of silicon, a silicon alloy, a compound containing silicon and oxygen, a compound containing silicon and nitrogen, a single body of tin, a tin alloy, a compound containing tin and oxygen, and a compound containing tin and nitrogen.

The material of the negative electrode current collector 2a may be, for example, copper foil, nickel foil, stainless steel foil or the like.

In the lithium secondary battery in this embodiment, as described in Embodiment 1, the nonaqueous solvent exhibits a high oxidation resistance owing to including a fluorine-containing cyclic carbonate represented by general formula (1). Therefore, the lithium secondary battery in this embodiment, even when being charged at a voltage exceeding 4.3 V, does not substantially cause actuation of a safety mechanism or is not substantially expanded, which would otherwise occur by oxidative decomposition of the nonaqueous solvent. In addition, deterioration in the battery performance, which would otherwise be caused by an influence of a reduction product generated in the negative electrode is suppressed. Therefore, lithium titanate is preferably usable as a negative electrode active material. This can suppress performance deterioration, which would otherwise be caused by deposition of lithium metal on the negative electrode or by an influence of the reduction product. Thus, a lithium secondary battery having a high energy density can be realized.

In this embodiment, a sheet-type lithium secondary battery is described as an example. The lithium secondary battery in this embodiment may have any other form. For example, the lithium secondary battery in this embodiment may have a cylindrical or polygonal shape, or may be large so as to be usable for an electric vehicle or the like.

The lithium secondary battery in this embodiment is preferably usable for mobile information terminals, mobile electronic devices, home-use compact power storage devices, motorcycles, electric vehicles, hybrid electric vehicles, and the like, as well as other devices.

### EXAMPLES

### Experiment 1

An electrolytic solution was prepared using a nonaqueous solvent for a lithium secondary battery in an embodiment according to the present application, and a voltage was applied to the electrolytic solution to measure a value of current flowing therein. Thus, the oxidation resistance of the electrolytic solution was evaluated.

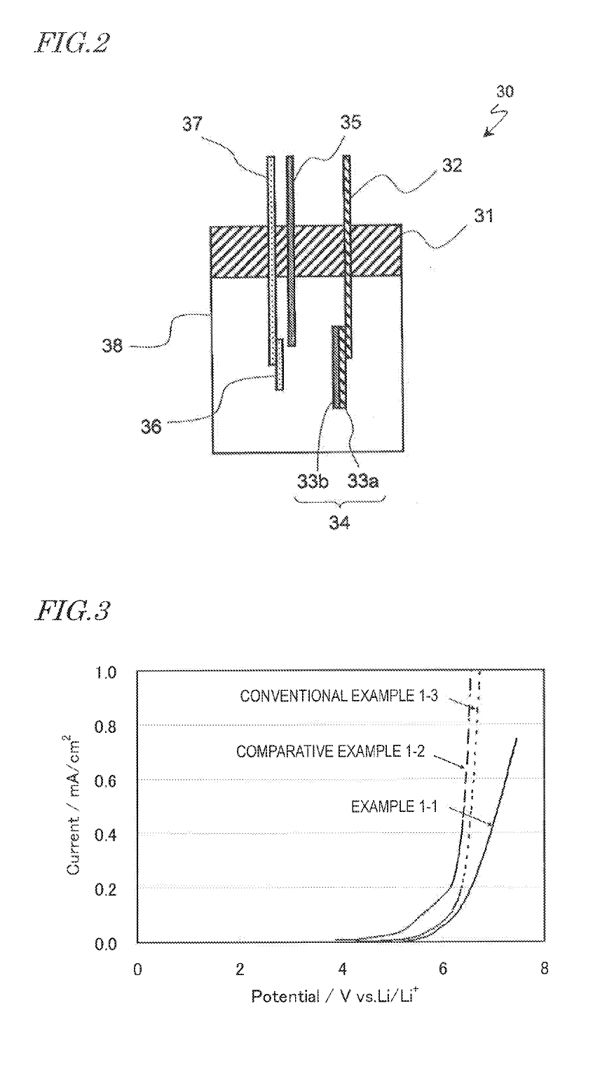

First, a three-electrode glass cell 30 shown in FIG. 2 was prepared. The three-electrode glass cell 30 includes a glass container 38, and a working electrode 36, a counter electrode 34 facing the working electrode 36, and a reference electrode 35, which are accommodated in the glass container 38. The working electrode 36 is a platinum plate (purity: 99.9% by weight) having a size of 1 cm×1 cm. The counter electrode 34 includes a stainless steel (SUS304) mesh 33a having a size of 2 cm×2 cm and a lithium foil 33b having a thickness of 150 μm and pressure-contacted on the mesh 33a. The reference electrode 35 is a lithium wire having a diameter of 2 mm. The working electrode 36 is connected to a platinum wire 37, and the counter electrode 34 is connected to a stainless steel wire 32. The platinum wire 37, the reference electrode 35 and the stainless steel wire 32 are each fixed by a rubber cap 31.

### Example 1-1

LiPF₆ (commercially available battery grade) as a support salt was dissolved in a mixed solvent obtained by mixing 4,5-difluoro-4,5-dimethyl-1,3-dioxorane-2-one and diethyl carbonate (DEC) (commercially available battery grade) at a volumetric ratio of 10:90, to prepare an electrolytic solution of Example 1-1. LiPF₆ had a concentration adjusted to be 0.1 mol/L.

4,5-difluoro-4,5-dimethyl-1,3-dioxorane-2-one was synthesized in accordance with a method disclosed in Japanese Laid-Open Patent Publication No. 2009-203225. The purity thereof was measured by gas chromatography (by use of a gas chromatographer produced by Shimadzu Corporation). The result was 99.2%.

### Comparative Example 1-2

LiPF₆ (commercially available battery grade) as a support salt was dissolved in a mixed solvent obtained by mixing 4-fluoro-1,3-dioxorane-2-one (FEC) (commercially available battery grade) and diethyl carbonate (DEC) (commercially available battery grade) at a volumetric ratio of 10:90, to prepare an electrolytic solution. LiPF₆ had a concentration adjusted to be 0.1 mol/L.

### Conventional Example 1-3

LiPF₆ (commercially available battery grade) as a support salt was dissolved in a mixed solvent obtained by mixing 1,3-dioxorane-2-one (EC) (commercially available battery grade) and diethyl carbonate (DEC) (commercially available battery grade) at a volumetric ratio of 10:90, to prepare an electrolytic solution. LiPF₆ had a concentration adjusted to be 0.1 mol/L.

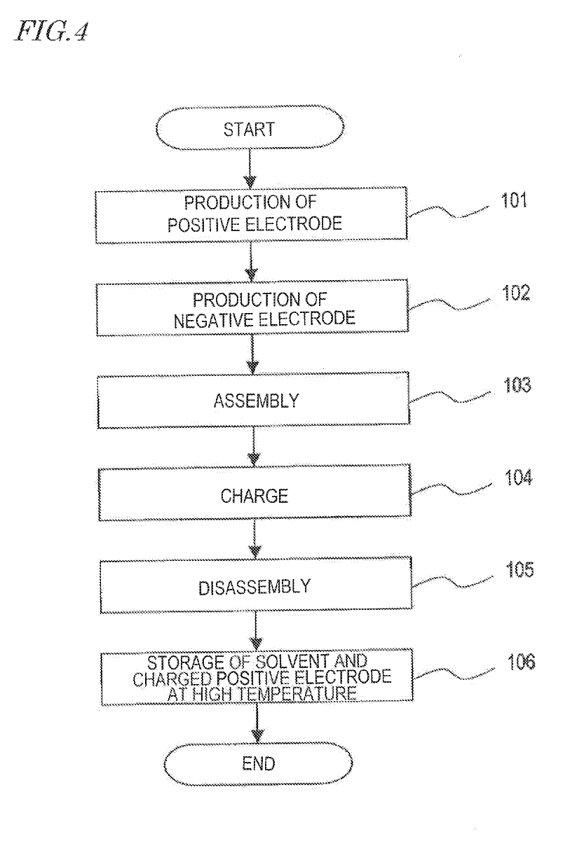

The electrolytic solutions of Example 1-1, Comparative example 1-2 and Conventional example 1-3 were each put into the three-electrode glass cell 30. The resultant three-electrode glass cells 30 were evaluation cells. A voltage-current curve of each evaluation cell was measured by a linear sweep voltammetry (LSV) method by use of an electrochemical analyzer having a maximum inter-electrode voltage of 26 V (produced by ALS Technology Co., Ltd.). The measurement was performed by sweeping the voltage of the working electrode with respect to the reference electrode from a natural open circuit voltage to 8 V at 5 mV/sec. Separately, a blank electrolytic solution was prepared by dissolving 0.1 mol/L of LiPF₆ (commercially available battery grade) as a support salt in a single solvent of DEC (commercially available battery grade). A voltage-current curve of the blank electrolytic solution was measured by the LSV method. The resultant voltage-current curve was subtracted from the voltage-current curve of each of Example 1-1, Comparative example 1-2 and Conventional example 1-3. The results are shown in FIG. 3 as voltage-current curves exhibiting oxidation behaviors of 4,5-difluoro-4,5-dimethyl-1,3-dioxorane-2-one, 4-fluoro-1,3-dioxorane-2-one, and 1,3-dioxorane-2-one.

As shown in FIG. 3, the current value of the electrolytic solution of Example 1-1 is smaller than the current values of the electrolytic solutions of Comparative example 1-2 and Conventional example 1-3 even when the voltage between the working electrode and the reference electrode is large. Especially in a voltage range exceeding 6.5 V, the increase in the current value of Example 1-1 is slower than those of Comparative example 1-2 and Conventional example 1-3. A current value measured by the LSV method is an index showing the rate of the oxidation reaction. Thus, FIG. 3 shows that the electrolytic solution of Example 1-1 has a splendid oxidation resistance. It is seen that especially the solvent in an embodiment according to the present application used in Example 1-1 is splendid as a solvent for an electrolytic solution of a high-voltage lithium secondary battery.

Especially with the electrolytic solution in Example 1-1, almost no current flows until the voltage is increased to about 5.0 V. From this, it is seen that the electrolytic solution is not substantially oxidized at a voltage of up to about 5.0 V. Therefore, it is understood that the electrolytic solution of Example 1-1 is preferably usable for an electricity storage device which is charged at a voltage in the range of 4.3 V or higher and 5.0 V or less, at which conventionally representative nonaqueous solvents for an electricity storage device, namely, ethylene carbonate, ethylmethyl carbonate, dimethyl carbonate, propylene carbonate and the like are oxidized.

The electrolytic solution of Comparative example 1-2 exhibits a conspicuously higher current value than that of Conventional example 1-3 in a voltage range exceeding 4.5 V. This indicates that the oxidation resistance of 4-fluoro-1,3-dioxorane-2-one is lower than that of 1,3-dioxorane-2-one, which is not fluorine-substituted. A conceivable reason for this is as follows. HF is eliminated by a chemical reaction and thus 1,3-dioxole-2-one having a carbon-carbon double bond is formed. After this, 1,3-dioxole-2-one is oxidative-decomposed. Because of an influence of this, the oxidation resistance of 4-fluoro-1,3-dioxorane-2-one is lower than that of 1,3-dioxorane-2-one.

### Experiment 2

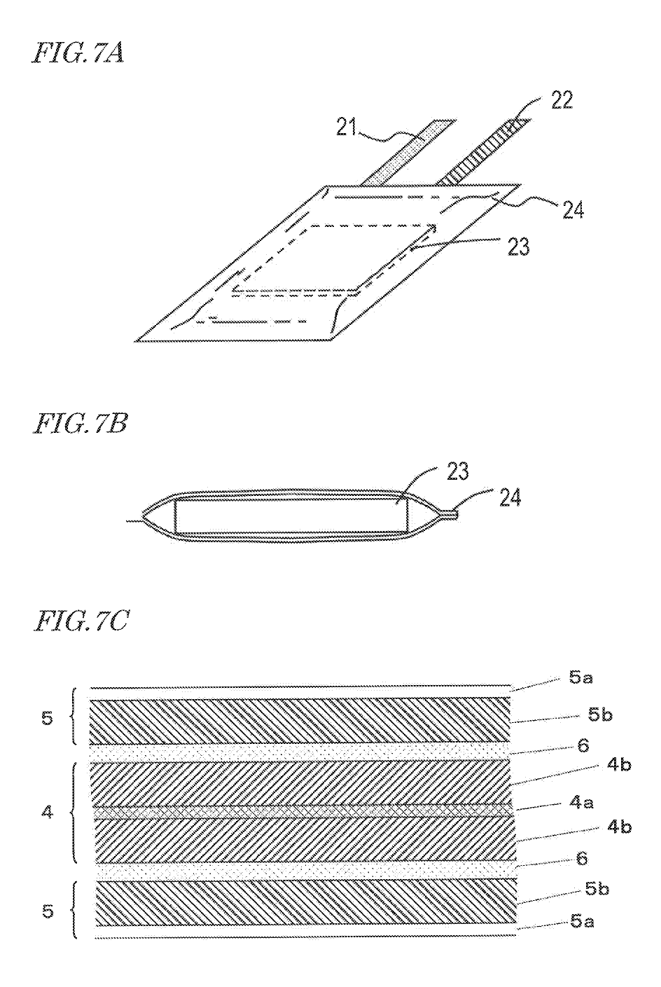

A solvent for an electricity storage device in an embodiment according to the present application and a positive electrode charged at a high voltage were enclosed together and stored at a high temperature. An amount of generated gas was measured. This experiment was performed in accordance with a flowchart shown in FIG. 4. FIGS. 7A, 7B and 7C show a structure of a lithium secondary battery produced in steps 101 through 103 in the flowchart in FIG. 4.

Hereinafter, each step of the flowchart shown in FIG. 4 will be described in detail.

### Production of the Positive Electrode (Step 101)

First, as the positive electrode active material, LiCoO₂ (average particle diameter: 10 μm; specific surface area by the BET method: 0.38 m²/g) was prepared. To 100 parts by weight of the active material, 3 parts by weight of acetylene black as a conductor, 4 parts by weight of poly(vinylidene fluoride) as a binder, and an appropriate amount of N-methyl-2-pyrrolidone were added, stirred and mixed to obtain a slurry-like positive electrode compound. The poly(vinylidene fluoride) was used in the state of being dissolved in N-methyl-2-pyrrolidone.

Next, as shown in FIG. 7C, the slurry-like positive electrode compound (positive electrode active material layer 4b) was applied on both of two surfaces of a positive electrode current collector 4a formed of an aluminum foil having a thickness of 20 μm. The applied layer was dried and extended by a roller.

LiCoO₂ used as the positive electrode active material was prepared as follows. While a saturated aqueous solution of cobalt sulfate was stirred at a low rate, an alkaline solution having sodium hydroxide dissolved therein was dropped thereto to obtain a precipitate of Co(OH)₂. This precipitate was filtrated, washed with water, and heated to 80° C. in the air to be dried. The average particle diameter of the obtained hydroxide was about 10 μm.

Next, the obtained hydroxide was heat-treated at 380° C. for 10 hours in the air to obtain an oxide, Co₂O₄. It was confirmed by powder X ray analysis that the obtained oxide had a single phase.

In addition, the obtained oxide was mixed with powder of lithium carbonate such that the ratio of the Co molarity and the Li molarity would be 1:1. The resultant mixture was heat-treated at 850° C. for 10 hours in dried air. Thus, the intended LiCoO₂ was obtained. It was confirmed by a powder X ray analyzer (produced by Rigaku Corporation) that the obtained LiCoO₂ had a single-phase hexagonal layer structure. After pulverization and classification, the obtained LiCoO₂ was observed with a scanning electron microscope (produced by Hitachi High-Technologies Corporation) to confirm that the particle diameter was about 6 to 15 μm. The average particle diameter was obtained by a scattering-type particle size distribution meter (produced by HORIBA, Ltd.).

The obtained electrode plate was punched out into the size shown in FIG. 5, and the positive electrode compound (positive electrode active material layer 4b) was delaminated from a tab, which was a lead attaching section. Thus, a positive electrode 4 was obtained. The positive electrode current collector 4a coated with the positive electrode compound (positive electrode active material layer 4b) has a rectangular shape of 30 mm×40 mm.

### Production of the Negative Electrode (Step 102)

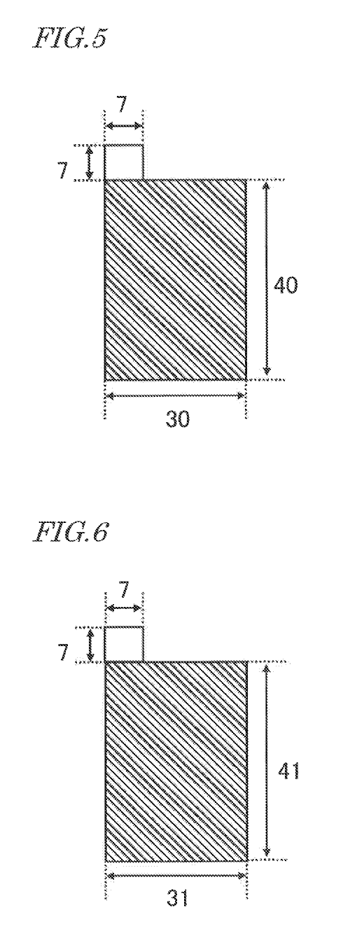

First, a stainless steel (SUS304) mesh was punched out into the size shown in FIG. 6 to form a negative electrode current collector 5a. The negative electrode current collector 5a includes an electrode section having a rectangular shape of 31 mm×41 mm and a lead attaching section having a square shape of 7 mm×7 mm. On the electrode section of the negative electrode current collector 5a, a lithium metal 5b having a thickness of 150w was pressure-contacted. Thus, a negative electrode 5 was obtained.

### Assembly (Step 103)

As shown in FIG. 7C, the obtained positive electrode 4 and negative electrode 5 were stacked with a separator 6 interposed therebetween to form an electrode unit 23. As the separator, a polyethylene microporous sheet having a thickness of 20 μm was used.

Next, as shown in FIG. 7A, a positive electrode lead 21 formed of aluminum was welded to the positive electrode 4 of the electrode unit 23, and a negative electrode lead 22 formed of nickel was welded to the negative electrode 5 of the electrode unit 23. Then, the electrode unit 23 was put into a battery case 24 opened on three sides and formed of an aluminum laminate film having a thickness of 0.12 mm. The electrode unit 23 was fixed to the inside of the battery case 24 with a tape formed of PP. Openings including an opening through which the positive electrode lead 21 and the negative electrode lead 22 were extended outside were thermally welded, and one opening was left opened without being thermally welded. Thus, the battery case 24 was formed like a bag. A prescribed amount of electrolytic solution 25 was injected through the opening not thermally welded. After the battery case 24 was treated with pressure reduction and deaeration, the opening was thermally welded in a lowered pressure state to seal the battery base as shown in FIG. 7B.

The electrolytic solution 25 was prepared by dissolving LiPF₆ (commercially available battery grade) as a support electrolyte salt in a mixed solvent obtained by mixing ethylene carbonate (EC) (commercially available battery grade) and EMC (commercially available battery grade) at a volumetric ratio of 1:3. LiPF₆ was dissolved so as to have a molarity of 1 mol/L in the electrolytic solution.

### Charge (Step 104)

The battery produced by steps 101 through 103 was charged at a constant current to 4.4V and 4.6V at a current value of 8 mA, and then kept at a constant voltage-charged state at 4.4V and 4.6V until the current value was attenuated to 1.6 mA.

### Disassembly (Step 105)

After the charge was finished, the battery was opened in an inert gas atmosphere having a dew point of −70° C., and the positive electrode 4 welded to the positive electrode lead 21 was taken out. Next, the tab of the positive electrode 4 was cut off to remove the electrode lead 21. Then, the positive electrode 4 deprived of the tab was immersed in dimethyl carbonate (DMC) (commercially available battery grade) to extract and remove the electrolytic solution contained in the positive electrode 4. After this, the positive electrode 4 was taken out from DMC and was dried in a vacuum state at room temperature to remove DMC. Thus, a positive electrode charged at a high voltage was obtained.

### Storage of the Solvent and the Charged Positive Electrode at a High Temperature (Step 106)

Six samples, namely, samples of Example 2-1, Example 2-2, Comparative example 2-3, Comparative example 2-4, Conventional example 2-5, and Conventional example 2-6 were produced by a method described below. These samples were produced for evaluating the capability of the solvent of generating gas when the solvent was stored at a high temperature in the presence of the charged positive electrode.

### Example 2-1

The 4.4V-charged positive electrode was accommodated in a bag of aluminum laminate film having a width of 50 mm and a height of 10 mm and having one side opened. As a solvent for evaluation, 3 ml of 4,5-difluoro-4,5-dimethyl-1,3-dioxorane-2-one was injected into the bag. Then, the opening was thermally welded in a lowered pressure state to seal the bag of aluminum laminate film.

### Example 2-2

Substantially the same process as in Example 2-1 was performed except that the 4.6V-charged positive electrode was used.

### Comparative Example 2-3

Substantially the same process as in Example 2-1 was performed except that 4-fluoro-1,3-dioxorane-2-one (FEC) (commercially available battery grade) was used as a solvent for evaluation.

### Comparative Example 2-4

Substantially the same process as in Comparative example 2-3 was performed except that the 4.6V-charged positive electrode was used.

### Conventional Example 2-5

Substantially the same process as in Example 2-1 was performed except that 1,3-dioxorane-2-one (EC) (commercially available battery grade) was used as a solvent for evaluation.

### Conventional Example 2-6

Substantially the same process as in Conventional example 2-5 was performed except that the 4.6V-charged positive electrode was used.

Six samples of Example 2-1, Example 2-2, Comparative example 2-3, Comparative example 2-4, Conventional example 2-5, and Conventional example 2-6, namely, sealed bags of laminate film, were put into a thermostat oven and stored at 85° C. for 3 days. Then, the samples were taken out from the thermostat oven, and quantitative analysis of generated gas was performed by gas chromatography (by use of a gas chromatographer produced by Shimadzu Corporation). Total amounts of generated gas calculated from the results are shown in Table 1.

TABLE 1

| | Charge | | Total amount |
|---|---|---|---|
| | voltage | | of generated |
| Sample | (V) | Type of solvent | gas (cm³) |
| Example 2-1 | 4.4 | 4,5-difluoro-4,5- | 0.03 |
| Example 2-2 | 4.6 | dimethyl-1,3- | 0.22 |
| | | dioxorane-2-one | |
| Comparative | 4.4 | 4-fluoro-1,3- | 0.58 |
| example 2-3 | | dioxorane-2-one | |
| Comparative | 4.6 | | 0.91 |
| example 2-4 | | | |
| Conventional | 4.4 | 1,3-dioxorane-2-one | 2.61 |
| example 2-5 | | | |
| Conventional | 4.6 | | 4.68 |
| example 2-6 | | | |

As shown in Table 1, in a storage test using Example 2-1, in which 4,5-difluoro-4,5-dimethyl-1,3-dioxorane-2-one in an embodiment according to the present application is combined with the 4.4 V-charged positive electrode, and also in a storage test using Example 2-2, in which 4,5-difluoro-4,5-dimethyl-1,3-dioxorane-2-one in an embodiment according to the present application is combined with the 4.6 V-charged positive electrode, the amount of generated gas is small. It is seen that oxidative decomposition is suppressed in the condition of a high voltage. Especially with Example 2-1 (4.4 V), the amount of generated gas is 0.03 cm³, which is extremely small. By contrast, with Comparative examples 2-3 and 2-4, in which 4-fluoro-1,3-dioxorane-2-one is used, an effect of suppressing gas generation is exhibited as compared with the conventional examples, but the amount of generated gas is larger than those of Examples 2-1 and 2-2. Especially when the charge voltage of the positive electrode is high, the amount of generated gas is large.

This is caused for the following reason. 4-fluoro-1,3-dioxorane-2-one used in the comparative examples, which is obtained by fluorinating 1,3-dioxorane-2-one used in the conventional examples, has an improved oxidation resistance as compared with the conventional examples, but causes a chemical reaction of HF elimination. HF elimination is considered to be caused because the chemical stability of 4-fluoro-1,3-dioxorane-2-one is insufficient.

### Experiment 3

Lithium secondary batteries were produced using LiNi_{0.5}Mn_{1.5}O₄ as a positive electrode active material, and the characteristics thereof were evaluated. Hereinafter, the results will be described.

### Preparation of the Electrolytic Solution

### Example 3-1

In Example 3-1, electrolytic solutions were produced using 4,5-difluoro-4,5-dimethyl-1,3-dioxorane-2-one and ethylmethyl carbonate as nonaqueous solvents and lithium hexafluorophosphate (LiPF₆) as a support electrolyte salt. Table 2 shows names, compositions and mixing states of the prepared samples. Each of the mixing ratios of 4,5-difluoro-4,5-dimethyl-1,3-dioxorane-2-one and ethylmethyl carbonate is represented by a volumetric ratio, and the concentration of the support electrolyte salt is represented by mol/L. The two nonaqueous solvents were not separated from each other at any of the mixing ratios, and the support electrolyte salt was completely dissolved at all the mixing ratios. Namely, the nonaqueous solvents and the support electrolyte salt were uniformly mixed, and thus good electrolyte solutions were obtained. Ethymethyl carbonate and the support electrolyte salt were both of the commercially available battery grade.

TABLE 2

| Name of | | Concentration | |
|---|---|---|---|
| electrolytic | Mixing | of support | Mixing |
| solution | ratio | electrolyte salt | state |
| 3-1-1 | 5:95 | 1M | Uniform |
| 3-1-2 | 10:90 | | Uniform |
| 3-1-3 | 25:75 | | Uniform |
| 3-1-4 | 50:50 | | Uniform |
| 3-1-5 | 75:25 | | Uniform |
| 3-1-6 | 90:10 | | Uniform |
| 3-1-7 | 95:5 | | Uniform |
| 3-1-8 | 100:0 | | Uniform |

### Comparative Example 3-2

In a comparative example, an electrolytic solution containing 4-fluoro-1,3-dioxorane-2-one as a solvent was prepared. The concentration of the support electrolyte salt was 1 mol/L. The solvent and the support electrolyte salt were both of the commercially available battery grade. The prepared electrolytic solution was labeled electrolyte solution 3-2-8.

### Conventional Example 3-3

In a conventional example, an electrolytic solution containing 1,3-dioxorane-2-one as a solvent was prepared. The concentration of the support electrolyte salt was 1 mol/L. The solvent and the support electrolyte salt were both of the commercially available battery grade. The prepared electrolytic solution was labeled electrolyte solution 3-4-8.

### Production of the Positive Electrode

First, as the positive electrode active material, LiNi_{0.5}Mn_{1.5}O₄ (average particle diameter: 13.6 μm; specific surface area by the BET method: 0.38 m²/g) was prepared. To 100 parts by weight of the active material, 3 parts by weight of acetylene black as a conductor, 4 parts by weight of poly(vinylidene fluoride) as a binder, and an appropriate amount of N-methyl-2-pyrrolidone were added, stirred and mixed to obtain a slurry-like positive electrode compound. The poly(vinylidene fluoride) was used in the state of being dissolved in N-methyl-2-pyrrolidone.

Next, as shown in FIG. 1C, the slurry-like positive electrode compound (positive electrode active material layer 1b) was applied on both of two surfaces of a positive electrode current collector 1a formed of an aluminum foil having a thickness of 20 μm. The applied layer was dried and extended by a roller.

LiNi_{0.5}Mn_{1.5}O₄ used as the positive electrode active material was prepared as follows. Powder of lithium hydroxide-hydrate was mixed to [Ni_{0.25}Mn_{0.75}](OH)₂, which was an eutectic oxide of nickel and manganese, such that the ratio of the total molarity of Ni and Mn and the Li molarity would be 2:1. The resultant mixture was heat-treated in the air. Thus, the intended LiNi_{0.5}Mn_{1.5}O₄ was obtained. The heat treatment was performed as follows. The ambient temperature was raised from room temperature to 1000° C. over 3 hours, was kept at 1000° C. for 12 hours, was lowered from 1000° C. to 700° C. over 30 minutes, was kept at 700° C. for 48 hours, and then lowered from 700° C. to room temperature over 1.5 hours. It was confirmed by a powder X ray analyzer (produced by Rigaku Corporation) that the obtained LiNi_{0.5}Mn_{1.5}O₄ had a single-phase spinel structure. After pulverization and classification, the obtained LiNi_{0.5}Mn_{1.5}O₄ was observed with a scanning electron microscope (produced by Hitachi High-Technologies Corporation) to confirm that the particle diameter was about 8 to 16 μm. The average particle diameter was obtained by a scattering-type particle size distribution meter (produced by HORIBA, Ltd.).

The obtained electrode plate was punched out into the size shown in FIG. 5, and the positive electrode compound (positive electrode active material layer 1b) was delaminated from a tab, which was a lead attaching section. Thus, a positive electrode 1 was obtained. The positive electrode current collector 1a coated with the positive electrode compound (positive electrode active material layer 1b) has a rectangular shape of 30 mm×40 mm.

### Production of the Negative Electrode

As the negative electrode active material, Li₄Ti₅O₁₂ was used. To 100 parts by weight of the active material, 3 parts by weight of acetylene black as a conductor, 4 parts by weight of poly(vinylidene fluoride) as a binder, and an appropriate amount of N-methyl-2-pyrrolidone were added, stirred and mixed to obtain a slurry-like negative electrode compound. The poly(vinylidene fluoride) was used in the state of being dissolved in N-methyl-2-pyrrolidone.

Next, as shown in FIG. 1C, the slurry-like negative electrode compound (negative electrode active material layer 2b) was applied on one surface of a negative electrode current collector 2a formed of an aluminum foil having a thickness of 20 μm. The applied layer was dried and extended by a roller.

Li₄Ti₅O₁₂ used as the negative electrode active material was of the commercially available battery grade and had an average particle diameter of 24 μm and a specific surface area by the BET method of 2.9 m²/g.

The obtained electrode plate was punched out into the size shown in FIG. 6, and the negative electrode compound (negative electrode active material layer 2b) was delaminated from a tab, which was a lead attaching section. Thus, a negative electrode 2 was obtained. The negative electrode current collector 2a coated with the negative electrode compound (negative electrode active material layer 2b) has a rectangular shape of 31 mm×41 mm. The weight of the negative electrode active material was adjusted such that the capacitance of the negative electrode would be sufficiently larger than the capacitance of the positive electrode.

### Assembly

The obtained positive electrode 1 and negative electrode 2 were stacked with a separator 3 interposed therebetween to form an electrode unit 13 as shown in FIG. 1C. As the separator, a polypropylene nonwoven cloth sheet having a thickness of 70 μm was used.

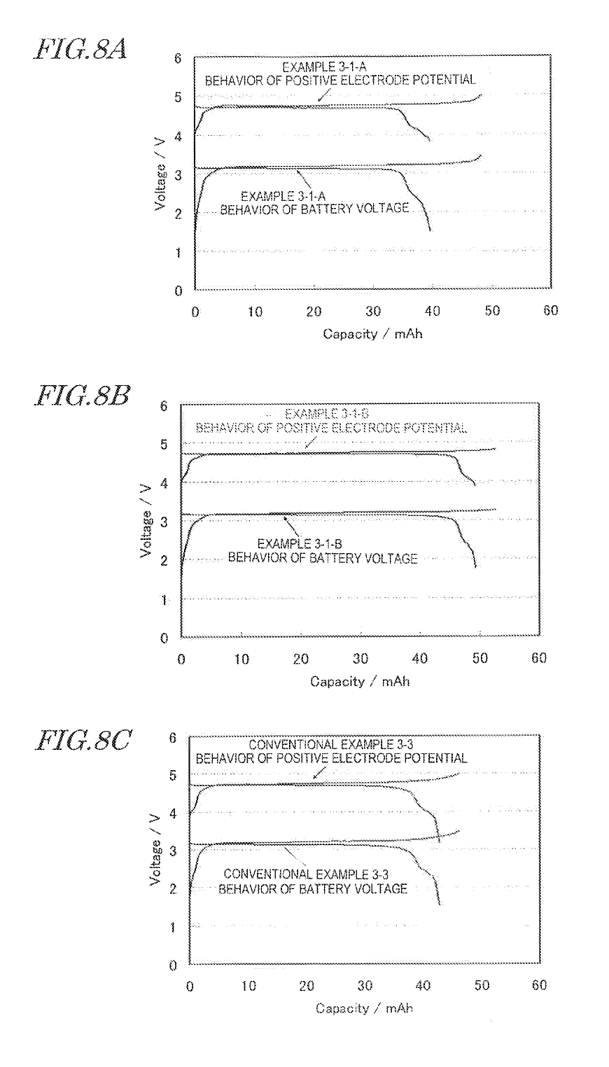

Next, as shown in FIG. 1A, a positive electrode lead 11 formed of aluminum was welded to the positive electrode 1 of the electrode unit 13, and a negative electrode lead 12 formed of aluminum was welded to the negative electrode 2 of the electrode unit 13. Then, the electrode unit 13 was put into a battery case 14 opened on three sides and formed of an aluminum laminate film having a thickness of 0.12 mm. The electrode unit 13 was fixed to the inside of the battery case 14 with a tape formed of polypropylene. Openings including an opening through which the positive electrode lead 11 and the negative electrode lead 12 were extended outside were thermally welded, and one opening was left opened without being thermally welded. Thus, the battery case 14 was formed like a bag. The electrolytic solutions each prepared as an electrolytic solution 15 were each injected through the opening not thermally welded. After the battery case 14 was treated with pressure reduction and deaeration, the opening was thermally welded in a lowered pressure state to seal the battery case. Table 3 shows compositions of the solvents used for the electrolytic solutions and names of the resultant batteries. The batteries each had a thickness of 0.5 mm, a width of 50 mm and a height of 100 mm. When each of the batteries was charged at 3.5 V, the designed capacitance thereof was 50 mAh. When each of the batteries was charged at a battery voltage of 3.5 V, the positive electrode potential was 5 V and the average positive electrode reaction potential was 4.7 V. FIGS. 8A, 8B and 8C respectively show the charge/discharge curves of the batteries of Example 3-1-A, Example 3-1-B and Conventional example 3-3. The battery of Comparative example 3-2 could not be charged/discharged.

TABLE 3

| | Used | |
|---|---|---|
| | electrolytic | Solvent for electrolytic |
| Battery name | solution | solution |
| Example 3-1-A | 3-1-8 | 4,5-difluoro-4,5-dimethyl-1,3- |
| | | dioxorane-2-one |
| Example 3-1-B | 3-1-3 | 4,5-difluoro-4,5-dimethyl-1,3- |
| | | dioxorane-2-one:ethylmethyl |
| | | carbonate = 25:75 (vol) |
| Comparative | 3-2-8 | 4-fluoro-1,3-dioxorane-2-one |
| example 3-2 | | |
| Conventional | 3-4-8 | 1,3-dioxorane-2-one |
| example 3-3 | | |

### Experiment 4

Lithium secondary batteries were produced using LiNi_{0.33}CO₀₃₃Mn_{0.33}O₂ as a positive electrode active material, and the characteristics thereof were evaluated. Hereinafter, the results will be described.

### Preparation of the Electrolytic Solution

### Example 4-1

In Example 4-1, an electrolytic solution containing 4,5-difluoro-4,5-dimethyl-1,3-dioxorane-2-one as a solvent and having a concentration of support electrolyte salt of 1 mol/L was prepared by substantially the same method as in Example 3-1.

### Comparative Example 4-2

In a comparative example, an electrolytic solution containing 4-fluoro-1,3-dioxorane-2-one as a solvent and having a concentration of support electrolyte salt of 1 mol/L was prepared by substantially the same method as in Comparative example 3-2.

### Conventional Example 4-3

In a conventional example, an electrolytic solution containing 1,3-dioxorane-2-one as a solvent and having a concentration of support electrolyte salt of 1 mol/L was prepared by substantially the same method as in Conventional example 3-3.

### Production of the Positive Electrode

As the positive electrode active material, LiNi_{0.33}CO_{0.33}Mn_{0.33}O₂ (average particle diameter: 8.5 μm; specific surface area by the BET method: 0.15 m²/g) was prepared. A positive electrode was produced by substantially the same method as in Experiment 3.

LiNi_{0.33}CO_{0.33}Mn_{0.33}O₂ used as the positive electrode active material was prepared as follows. Sulfates of Co and Mn were added at a prescribed ratio to an aqueous solution of nickel sulfate to prepare a saturated aqueous solution. While the saturated aqueous solution was stirred at a low rate, an alkaline solution having sodium hydroxide dissolved therein was dropped thereto for neutralization to obtain a precipitate of [Ni_{0.33}Co_{0.33}Mn_{0.33}](OH)₂, which was a three-component-system hydroxide. This precipitate was filtrated, washed with water, and heated to 80° C. in the air to be dried. The average particle diameter of the obtained hydroxide was about 8 μm.

Next, the obtained hydroxide was heat-treated at 380° C. for 10 hours in the air to obtain [Ni_{0.33}Co_{0.33}Mn_{0.33}]O, which was a three-component-system oxide. It was confirmed by powder X ray analysis that the obtained oxide had a single phase.

Powder of lithium hydroxide-hydrate was mixed to the obtained oxide, such that the ratio of the total molarity of Ni, Co and Mn and the Li molarity would be 1:1. The resultant mixture was heat-treated at 1000° C. for 10 hours in dried air. Thus, the intended LiNi_{0.33}Co_{0.33}Mn_{0.33}O₂ was obtained. It was confirmed by a powder X ray analyzer (produced by Rigaku Corporation) that the obtained LiNi_{0.33}CO_{0.33}Mn_{0.33}O₂ had a single-phase hexagonal layer structure and that Co and Mn were in a state of solid solution. After pulverization and classification, the obtained LiNi_{0.33}CO_{0.33}Mn_{0.33}O₂ was observed with a scanning electron microscope (produced by Hitachi High-Technologies Corporation) to confirm that a great number of primary particles having a diameter of about 0.1 μm to 1.0 μm were aggregated to form generally spherical or ellipsoidal secondary particles. The average particle diameter was obtained by a scattering-type particle size distribution meter (produced by HORIBA, Ltd.).

### Production of the Negative Electrode

The negative electrode was produced using Li₄Ti₅O₁₂ by substantially the same method as in Experiment 3.

### Assembly

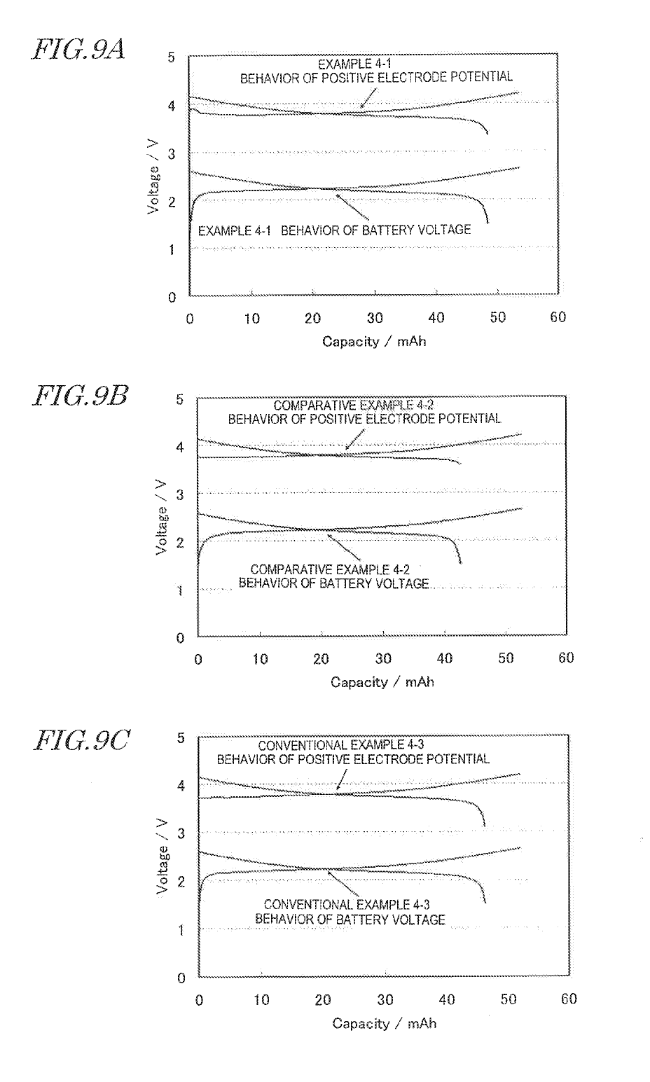

Batteries were produced by substantially the same method as in Experiment 3 except that LiNi_{0.33}Co_{0.33}Mn_{0.33}O₂ was used as the positive electrode active material. Table 4 shows compositions of the solvents used for the electrolytic solutions and names of the resultant batteries. When each of the batteries was charged at 2.65 V, the designed capacitance thereof was 50 mAh. When each of the batteries was charged at a battery voltage of 2.65 V, the positive electrode potential was 4.2 V. FIGS. 9A, 9B and 9C respectively show the charge/discharge curves of the batteries of Example 4-1, Comparative example 4-2 and Conventional example 4-3.

TABLE 4

| Battery name | Solvent for electrolytic solution |
|---|---|
| Example 4-1 | 4,5-difluoro-4,5-dimethyl-1,3- |
| | dioxorane-2-one |
| Comparative example 4-2 | 4-fluoro-1,3-dioxorane-2-one |
| Conventional example 4-3 | 1,3-dioxorane-2-one |

As shown in FIG. 8A through 8C and FIG. 9A through 9C, Examples 3-1-A and 4-1 using 4,5-difluoro-4,5-dimethyl-1,3-dioxorane-2-one exhibit the charge/discharge characteristics substantially the same as those of Conventional examples 3-3 and 4-3 using 1,3-dioxorane-2-one. By contrast, when 4-fluoro-1,3-dioxorane-2-one is used, the results are as follows. Comparative example 4-2 in which the positive electrode potential is 4.2 V exhibits substantially the same level of performance as above, whereas in Comparative example 3-2 in which the positive electrode potential is 4.7 V, the battery could not be charged/discharged. This is caused for the reason described above regarding the gas generation in Comparative example 2-4. In 4-fluoro-1,3-dioxorane-2-one used in Comparative example 3-2, a fluorine atom and a hydrogen atom are bonded to carbons at positions 4 and 5 adjacent to each other of the cyclic carbonate skeleton. This causes a chemical reaction of HF elimination. HF elimination is considered to be caused because the chemical stability of 4-fluoro-1,3-dioxorane-2-one is insufficient.

By contrast, in 4,5-difluoro-4,5-dimethyl-1,3-dioxorane-2-one used in the batteries in an embodiment according to the present application, no hydrogen atom is bonded to the carbons at positions 4 and 5 of the cyclic carbonate skeleton, and a fluorine atom and a hydrogen atom are not bonded to the carbons at positions 4 and 5 adjacent to each other on a five-member ring. It is considered that owing to such a structure, 4,5-difluoro-4,5-dimethyl-1,3-dioxorane-2-one has a splendid stability and provides a high charge/discharge characteristic. In Example 3-1-B using a mixed solvent of 4,5-difluoro-4,5-dimethyl-1,3-dioxorane-2-one and ethylmethyl carbonate provides a better characteristic than that of Example 3-1-A using only 4,5-difluoro-4,5-dimethyl-1,3-dioxorane-2-one as a solvent. A conceivable reason for this is that use of a mixed solvent with a chain carbonate provides an effect of improving the characteristic, like in the case of a general electrolytic solution using 1,3-dioxorane-2-one or the like.

According to an embodiment of the present application, a nonaqueous solvent and a nonaqueous electrolytic solution for an electricity storage device, and an electricity storage device, which exhibit a splendid oxidation resistance at a high voltage exceeding 4.3 V and also exhibit a splendid charge/discharge characteristic and a high reliability at a high energy density are realized. An embodiment according to the present application is preferably usable especially for various types of electricity storage devices charged at a high voltage.

While the present invention has been described with respect to preferred embodiments thereof, it will be apparent to those skilled in the art that the disclosed invention may be modified in numerous ways and may assume many embodiments other than those specifically described above. Accordingly, it is intended by the appended claims to cover all modifications of the invention that fall within the true spirit and scope of the invention.

What is claimed is:

1. A nonaqueous solvent for an electricity storage device including a fluorine-containing cyclic carbonate represented by the following general formula (1) (in general formula (1), R₁ is a methyl group or an ethyl group; R₂ through R₄ are independently fluorine, a methyl group or an ethyl group; and at least one of R₂ through R₄ is fluorine):

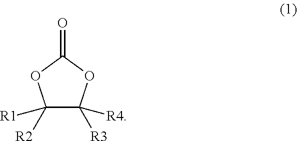

2. The nonaqueous solvent for an electricity storage device of claim 1, wherein the fluorine-containing cyclic carbonate represented by general formula (1) is 4,5-difluoro-4,5-dimethyl-1,3-dioxorane-2-one.

3. A nonaqueous electrolytic solution for an electricity storage device, comprising:
the nonaqueous solvent for an electricity storage device defined by claim 1; and
a support electrolyte salt.

4. The nonaqueous electrolytic solution for an electricity storage device of claim 3, wherein the support electrolyte salt is a lithium salt.

5. The nonaqueous electrolytic solution for an electricity storage device of claim 3, wherein the support electrolyte salt is a quaternary ammonium salt.

6. An electricity storage device, comprising the nonaqueous electrolytic solution for an electricity storage device defined by claim 3.

7. A lithium secondary battery, comprising:
a positive electrode;
a negative electrode; and
the nonaqueous electrolytic solution for an electricity storage device defined by claim 3.

8. The lithium secondary battery of claim 7, wherein the negative electrode includes Li₄Ti₅O₁₂.

9. The lithium secondary battery of claim 7, wherein the positive electrode includes LiNi_{0.33}CO_{0.33}Mn_{0.33}O₂.

10. The lithium secondary battery of claim 7, wherein the positive electrode includes LiNi_{0.5}Mn_{1.5}O₄.

11. The lithium secondary battery of claim 7, wherein the positive electrode is constructed to be charged at a potential in the range of 4.3 V or higher and 5.0 V or less on the basis of a standard redox potential of lithium.
